(19) United States
(12) Patent Application Publication
(10) Pub. No.: US 2017/0158089 A1
(43) Pub. Date: Jun. 8, 2017

(54) APPARATUS AND METHOD FOR COMPENSATING FOR ANGLE OF SEATBACK FOR VEHICLE

(71) Applicants: HYUNDAI MOTOR COMPANY, Seoul (KR); KIA MOTORS CORPORATION, Seoul (KR)

(72) Inventor: Jeong Ki LEE, Seoul (KR)

(73) Assignees: HYUNDAI MOTOR COMPANY, Seoul (KR); KIA MOTORS CORPORATION, Seoul (KR)

(21) Appl. No.: 15/158,474

(22) Filed: May 18, 2016

(30) Foreign Application Priority Data
Dec. 3, 2015 (KR) 10-2015-0171730

(51) Int. Cl. B60N 2/02; B60N 2/22

(52) U.S. Cl. CPC B60N 2/0248; B60N 2/0232; B60N 2/22; B60N 2002/0272

(57) ABSTRACT

An apparatus for compensating for an angle of a seatback for a vehicle includes a memory for storing an angle of a seatback set by a vehicle operator, a hall sensor for generating a pulse signal according to a rotation of a motor, a motor driver for driving the motor to adjust the angle of the seatback, and a controller for detecting variations in the angle of the seatback in forward and reverse directions using a width of the pulse signal generated by the hall sensor, and compensating for the angle of the seatback on the basis of the detected variations.

### CROSS-REFERENCE TO RELATED APPLICATION

This application claims the benefit of priority to Korean Patent Application No. 10-2015-0171730, filed on Dec. 3, 2015 with the Korean Intellectual Property Office, the disclosure of which is incorporated herein in its entirety by reference.

### TECHNICAL FIELD

The present disclosure relates to an apparatus and a method for compensating for an angle of a seatback for a vehicle and, more particularly, to an apparatus and a method for compensating for unintended variations in an angle of a seatback with an integrated memory system (IMS) using a single hall sensor to detect an angle of a seatback according to rotation of a motor.

### BACKGROUND

In general, an integrated memory system (IMS) adjusts an angle of a seatback by driving a motor on the basis of information about an angle of a seatback stored in a memory at the request of a vehicle operator.

While the vehicle operator leans against the seatback, even after the driving of the motor is stopped, a variation in the angle of the seatback in a forward direction due to the inertia of the motor and a variation in the angle of the seatback in a reverse direction due to the load of the vehicle operator or a repulsive force may occur. Here, the forward direction angle variation refers to a variation in the angle of the seatback in a direction corresponding to the rotation of the motor, while the reverse direction angle variation is opposite to the forward direction angle variation.

Such an additional variation in the angle of the seatback disturbs precise adjustment of the angle of the seatback, and thus serves as a factor in degrading the performance of the IMS.

A conventional IMS detects an angle of a seatback according to rotation of a motor by using a hall sensor. However, since a single hall sensor is used, it is difficult to detect whether the additional variation in the angle of the seatback is in the forward direction or in the reverse direction.

Therefore, the conventional IMS cannot compensate for the additional variation in the angle of the seatback.

### SUMMARY

The present disclosure has been made to solve the above-mentioned problems occurring in the prior art while advantages achieved by the prior art are maintained intact.

An aspect of the present disclosure provides an apparatus and a method for compensating for unintended variations in an angle of a seatback for a vehicle, in an integrated memory system (IMS) using a single hall sensor to detect an angle of a seatback according to a rotation of a motor, by detecting variations in the angle of the seatback in forward and reverse directions using widths of pulse signals generated by the hall sensor according to the rotation of the motor.

The object of the present disclosure is not limited to the foregoing object, and any other objects and advantages not mentioned herein will be clearly understood from the following description. The present inventive concept will be more clearly understood from exemplary embodiments of the present disclosure. In addition, it will be apparent that the objects and advantages of the present disclosure can be achieved by means claimed in the claims and a combination thereof.

According to an aspect of the present disclosure, an apparatus for compensating for an angle of a seatback for a vehicle may include: a memory for storing an angle of a seatback set by a vehicle operator; a hall sensor for generating a pulse signal according to a rotation of a motor; a motor driver for driving the motor to adjust the angle of the seatback; and a controller for detecting variations in the angle of the seatback in forward and reverse directions using a width of the pulse signal generated by the hall sensor, and compensating for the angle of the seatback on the basis of the detected variations.

According to another aspect of the present disclosure, a method for compensating for an angle of a seatback for a vehicle may include: driving, by a motor driver, a motor to adjust an angle of a seatback; generating, by a hall sensor, a pulse signal according to rotation of the motor; detecting, by a controller, variations in the angle of the seatback in forward and reverse directions using a width of the generated pulse signal; and compensating, by the controller, for the angle of the seatback on the basis of the detected variations in the angle of the seatback in the forward and reverse directions.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a configuration of an apparatus for compensating for an angle of a seatback for a vehicle according to an exemplary embodiment of the present disclosure;

FIG. 2 is a view illustrating examples of a pulse signal generated by a hall sensor according to an exemplary embodiment of the present disclosure; and

FIG. 3 is a flowchart illustrating a method for compensating for an angle of a seatback for a vehicle according to an exemplary embodiment of the present disclosure.

### DETAILED DESCRIPTION

The above and other objects, features and advantages of the present disclosure will be more clearly understood from the following detailed description taken in conjunction with the accompanying drawings so that those skilled in the art to which the present disclosure pertains can easily carry out technical ideas described herein. In addition, a detailed description of well-known techniques associated with the present disclosure will be ruled out in order not to unnecessarily obscure the concepts of the present disclosure. Hereinafter, exemplary embodiments of the present disclosure will be described in detail with reference to the accompanying drawings.

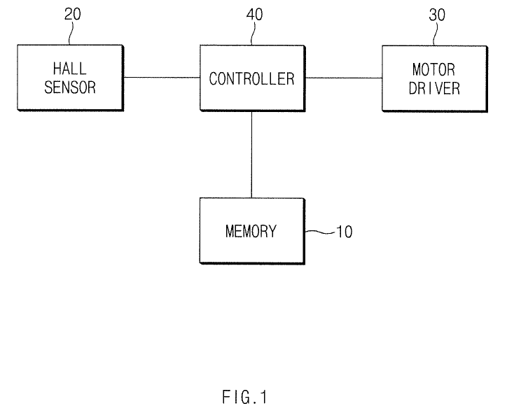

FIG. 1 is a view illustrating a configuration of an apparatus for compensating for an angle of a seatback for a vehicle according to an exemplary embodiment of the present disclosure.

As illustrated in FIG. 1, the apparatus for compensating for an angle of a seatback for a vehicle according to the exemplary embodiment of the present disclosure may include a memory 10, a hall sensor 20, a motor driver 30 and a controller 40.

With respect to each of the aforementioned elements, first, the memory 10 may store information about an angle of a seatback set by a vehicle operator. Here, the memory may be configured as a memory of an integrated memory system (IMS), or may be interlocked with the memory of the IMS.

Next, the hall sensor 20 may generate a pulse signal according to a rotation of a motor for adjusting the angle of the seatback.

That is, the hall sensor 20 may generate pulse signals having different widths according to a speed of the motor. Here, as the speed of the motor is increased, a pulse signal having a relatively narrow width may be generated, and as the speed of the motor is reduced, a pulse signal having a relatively wide width may be generated.

The motor driver 30 may drive the motor under control of the controller 40.

The controller 40 generally may control the aforementioned respective elements to perform the functions thereof normally.

In particular, the controller 40 may adjust the angle of the seatback by driving the motor on the basis of the information about the angle of the seatback stored in the memory 10 at the request of the vehicle operator.

Here, the controller 40 may compensate for the angle of the seatback by detecting unintended variations in the angle of the seatback after the operation of the motor driver 30 is stopped. That is, the controller 40 may detect variations in the angle of the seatback in forward and reverse directions by using the widths of the pulse signals generated by the hall sensor 20, and compensate for the angle of the seatback on the basis of the detected variations.

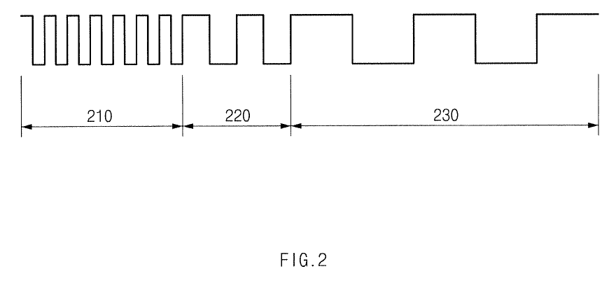

Hereinafter, a pulse signal generated by the hall sensor 20 will be detailed with reference to FIG. 2.

FIG. 2 is a view illustrating examples of a pulse signal generated by the hall sensor according to an exemplary embodiment of the present disclosure.

In FIG. 2, a first pulse signal, indicated by 210, may be generated by the hall sensor 20 when the motor is rotated by the motor driver 30, and may indicate that the angle of the seatback is adjusted in a forward direction. Here, the width of the first pulse signal may be narrower than the width of a second pulse signal and the width of a third pulse signal.

The second pulse signal indicated by 220 may be generated by the hall sensor 20 when the motor is rotated by the inertia of the motor rather than by the motor driver 30, and may indicate that the angle of the seatback is adjusted in a forward direction. Here, the width of the second pulse signal may be wider than the width of the first pulse signal, but may be narrower than the width of the third pulse signal.

The third pulse signal indicated by 230 may be generated by the hall sensor 20 when the motor is reversely rotated by the load of the vehicle operator or repulsive force, and may indicate that the angle of the seatback is adjusted in a reverse direction. Here, the width of the third pulse signal may be wider than the width of the second pulse signal.

The controller 40 may determine the direction of rotation of the motor by checking the width of the pulse signal generated by the hall sensor 20.

That is, when the width of the pulse signal generated by the hall sensor 20 exceeds a threshold value (for example, the width of the second pulse signal), the controller 40 may determine that the angle of the seatback is varied in the reverse direction. Unless the width of the pulse signal exceeds the threshold value, the controller 40 may determine that the angle of the seatback is varied in the forward direction.

The controller 40 may perform the adjustment of the angle of the seatback, which is intended, by using the first pulse signal, and may perform the adjustment of the angle of the seatback, which is unintended, by using the second pulse signal and the third pulse signal.

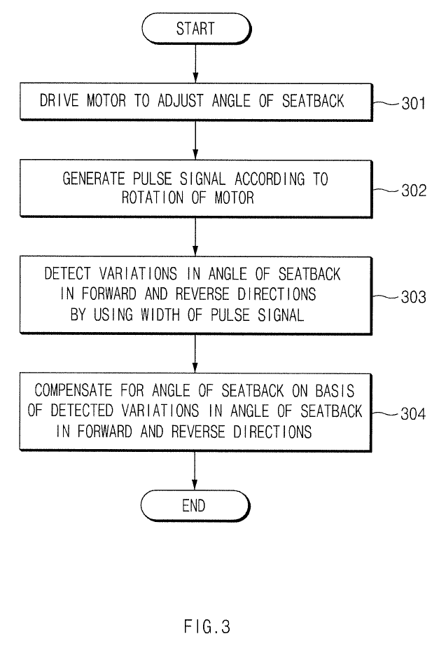

FIG. 3 is a flowchart illustrating a method for compensating for an angle of a seatback for a vehicle according to an exemplary embodiment of the present disclosure.

First, the motor driver 30 may drive the motor under control of the controller 40 to adjust an angle of a seatback in operation 301.

Next, the hall sensor 20 may generate pulse signals according to rotation of the motor in operation 302.

Thereafter, the controller 40 may detect variations in the angle of the seatback in forward and reverse directions by using the widths of the pulse signals generated by the hall sensor 20 in operation 303.

Then, the controller 40 may compensate for the angle of the seatback on the basis of the detected variations in the angle of the seatback in the forward and reverse directions in operation 304.

Throughout these operations, unintended variations in the angle of the seatback may be compensated for.

Meanwhile, the above-stated method according to the exemplary embodiment of the present disclosure may be written as a computer program. Codes and code segments constituting the program may easily be inferred by a computer programmer skilled in the art. In addition, the written program may be stored in a computer-readable recording medium (an information storage medium) and be read and executed by a computer, thereby implementing the method according to the exemplary embodiment of the present disclosure. The recording medium includes all types of computer-readable recording media.

As set forth above, in an integrated memory system (IMS) using a single hall sensor to detect an angle of a seatback according to rotation of a motor, unintended variations in the angle of the seatback may be compensated for by detecting variations in the angle of the seatback in forward and reverse directions by using widths of pulse signals generated by the hall sensor.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus for compensating for an angle of a seatback for a vehicle, the apparatus comprising:
a memory for storing an angle of a seatback set by a vehicle operator;
a hall sensor for generating a pulse signal according to a rotation of a motor;
a motor driver for driving the motor to adjust the angle of the seatback; and
a controller for detecting variations in the angle of the seatback in forward and reverse directions using a width of the pulse signal generated by the hall sensor, and compensating for the angle of the seatback on the basis of the detected variations.

2. The apparatus according to claim 1, wherein the controller determines that the angle of the seatback is varied in the reverse direction when the width of the pulse signal generated by the hall sensor exceeds a threshold value, and determines that the angle of the seatback is varied in the forward direction when the width of the pulse signal generated by the hall sensor does not exceed the threshold value.

3. The apparatus according to claim 1, wherein the controller controls the motor driver to compensate for the angle of the seatback.

4. The apparatus according to claim 1, wherein the memory is interlocked with a memory of an integrated memory system (IMS).

5. The apparatus according to claim 1, wherein the hall sensor generates pulse signals having different widths according to a speed of rotation of the motor.

6. The apparatus according to claim 5, wherein the hall sensor generates a pulse signal having a narrow width when the speed of the motor is increased.

7. The apparatus according to claim 5, wherein the hall sensor generates a pulse signal having a wide width when the speed of the motor is reduced.

8. A method for compensating for an angle of a seatback for a vehicle, the method comprising:
driving, by a motor driver, a motor to adjust an angle of a seatback;
generating, by a hall sensor, a pulse signal according to a rotation of the motor;
detecting, by a controller, variations in the angle of the seatback in forward and reverse directions using a width of the generated pulse signal; and
compensating, by the controller, for the angle of the seatback on the basis of the detected variations in the angle of the seatback in the forward and reverse directions.

9. The method according to claim 8, wherein, in the step of compensating for the angle of the seatback, it is determined that the angle of the seatback is varied in the reverse direction when the width of the pulse signal generated by the hall sensor exceeds a threshold value, and it is determined that the angle of the seatback is varied in the forward direction when the width of the pulse signal generated by the hall sensor does not exceed the threshold value.

10. The method according to claim 8, wherein the controller controls the motor driver to compensate for the angle of the seatback.

11. The method according to claim 8, wherein the angle of the seatback is obtained from a memory of an integrated memory system (IMS).

12. The method according to claim 8, wherein the hall sensor generates pulse signals having different widths according to a speed of rotation of the motor.

13. The method according to claim 12, wherein the hall sensor generates a pulse signal having a narrow width when the speed of the motor is increased.

14. The method according to claim 12, wherein the hall sensor generates a pulse signal having a wide width when the speed of the motor is reduced.
